(19) United States
(12) Patent Application Publication
(10) Pub. No.: US 2011/0189518 A1
(43) Pub. Date: Aug. 4, 2011

(54) NONAQUEOUS ELECTROLYTE SECONDARY BATTERY

(76) Inventors: Hideaki Fujita, Kyoto (JP); Takashi Hosokawa, Osaka (JP)

(21) Appl. No.: 13/122,645

(22) PCT Filed: Jul. 13, 2010
(86) PCT No.: PCT/JP2010/004544

§ 371 Date: Apr. 5, 2011

(30) Foreign Application Priority Data
Aug. 7, 2009 (JP) 2009-184377

(51) Int. Cl. H01M 4/02; H01M 2/02

(52) U.S. Cl. 429/94

(57) ABSTRACT

The present invention provides a high-output, and long-life nonaqueous electrolyte secondary battery. The nonaqueous electrolyte secondary battery includes: an electrode group which is formed by winding a positive electrode 5 including an active material layer formed on a surface of a current collector, and a negative electrode 6 including an active material layer formed on a surface of a current collector with a porous insulator 7 interposed therebetween, and is sealed in a battery case, wherein the electrode group is configured in such a manner that uniform surface pressure is applied to turns of the positive electrode 5, the negative electrode 6, and the porous insulator 7 during the winding.

### TECHNICAL FIELD

The present invention relates to nonaqueous electrolyte secondary batteries.

### BACKGROUND ART

Nonaqueous electrolyte secondary batteries, such as lithium secondary batteries, have high operation voltage, and high energy density. For this reason, the nonaqueous electrolyte secondary batteries have been and are being used as power sources for driving portable electronic devices, such as cellular phones, notebook computers, video cam recorders, etc., and are rapidly growing in industry.

Not only as batteries for the above-described small-size consumer products, the nonaqueous electrolyte secondary batteries are also used as large-size batteries for electric vehicles and power storage, and as large-size batteries for driving motors of hybrid electric vehicles (HEV), etc.

For example, the nonaqueous electrolyte secondary batteries for driving the motors of the HEVs are required to produce high output to improve acceleration performance, gradeability, and fuel efficiency of the HEVs. Specifically, although for a short time, such nonaqueous electrolyte secondary batteries for driving the motors have to generate a current of 20-40 C hour rate, which is several ten times higher than a current of batteries for general portable devices.

Thus, the batteries for the electric vehicles and hybrid electric vehicles are required to produce high output. To meet the requirement, a so-called tabless current collecting structure in which a lateral end of each electrode is not covered with an active material layer, and is exposed has been and are being employed to reduce resistance in current collection.

Patent Document 1 relates to a tabless cylindrical electrode group formed by winding a positive electrode and a negative electrode with a separator interposed therebetween, and teaches a technology of providing a conductive strip between turns of the exposed part of each of the current collectors of the electrode group to increase an area in which the conductive strip contacts the current collector. This allows connecting the conductive strip to the current collector along the whole length of the current collector, thereby reducing the resistance in current collection. This technology has also addressed improvement in durability of the battery to withstand oscillation and impact.

Patent Document 2 also relates to a tabless cylindrical electrode group, and teaches a technology of providing a reinforcing member, such as a porous member, on the exposed part of each of the current collectors of the electrode group. This can increase the output of the battery, and can reduce a short circuit caused in the electrode group by a foreign matter which accidentally enters the electrode group from the end of the electrode group.

### CITATION LIST

### Patent Documents

[Patent Document 1] Japanese Patent Publication No. 2004-22339
[Patent Document 2] Japanese Patent Publication No. 2008-21644

### SUMMARY OF THE INVENTION

### Technical Problem

In winding the electrodes into the cylindrical shape, positive and negative electrodes are wound with a porous insulator interposed therebetween, while a constant tension is applied to a core. In this case, as the electrodes are wound around the core from a first wound part to a last wound part, surface pressure applied between the positive electrode and the negative electrode is gradually reduced, i.e., the surface pressure varies from the first wound part to the last wound part. Due to the variations in surface pressure, a distance between the positive electrode and the negative electrode varies, a distance between the electrodes varies due to the degree of compression of the porous insulator, and the amount of an electrolyte held between the electrodes varies, thereby varying resistance of the electrolyte interposed between the positive and negative electrodes. As a result, a current flowing through the charge/discharge of the battery is distributed unevenly due to the varied resistance of the electrolyte. When the charge/discharge is repeated, battery capacity may be reduced due to uneven charge/discharge reaction.

In view of the foregoing, the present invention provides a nonaqueous electrolyte secondary battery in which the surface pressure is uniformly applied to cause a uniform charge/discharge reaction between the positive and negative electrodes, thereby improving battery life.

### Solution to the Problem

To achieve the object, a nonaqueous electrolyte secondary battery of the present invention includes: a strip-shaped positive electrode including a positive electrode active material layer formed on a surface of a positive electrode current collector; a strip-shaped negative electrode including a negative electrode active material layer formed on a surface of a negative electrode current collector; a strip-shaped porous insulator interposed between the positive electrode and the negative electrode; a nonaqueous electrolyte; and a battery case containing the positive electrode, the negative electrode, the porous insulator, and the nonaqueous electrolyte, wherein an electrode group formed by winding the positive electrode, the negative electrode, and the porous insulator is sealed in the battery case, and a pressure which is applied to a portion of the electrode group where the positive electrode active material layer and the negative electrode active material layer are provided is substantially uniform from a first wound part to a last wound part of the portion of the electrode group.

### Advantages of the Invention

In the present invention, the electrode group is configured in such a manner that the surface pressure is applied uniformly in the winding direction to turns of the positive electrode, the negative electrode, and the porous insulator during the winding. Thus, the charge/discharge reaction can occur uniformly between the electrodes, and uneven reaction through repeated charge/discharge can be reduced, thereby increasing battery life.

### BRIEF DESCRIPTION OF THE DRAWINGS

FIG. 1 is a schematic view illustrating an electrode of a battery of the present invention.

FIG. 2 is a schematic cross-sectional view illustrating an electrode group the battery of the present invention.

FIG. 3 is a schematic view illustrating the battery of the present invention.

FIG. 4 is a graph illustrating charge/discharge cycle characteristics of batteries.

### DESCRIPTION OF EMBODIMENTS

### First Embodiment

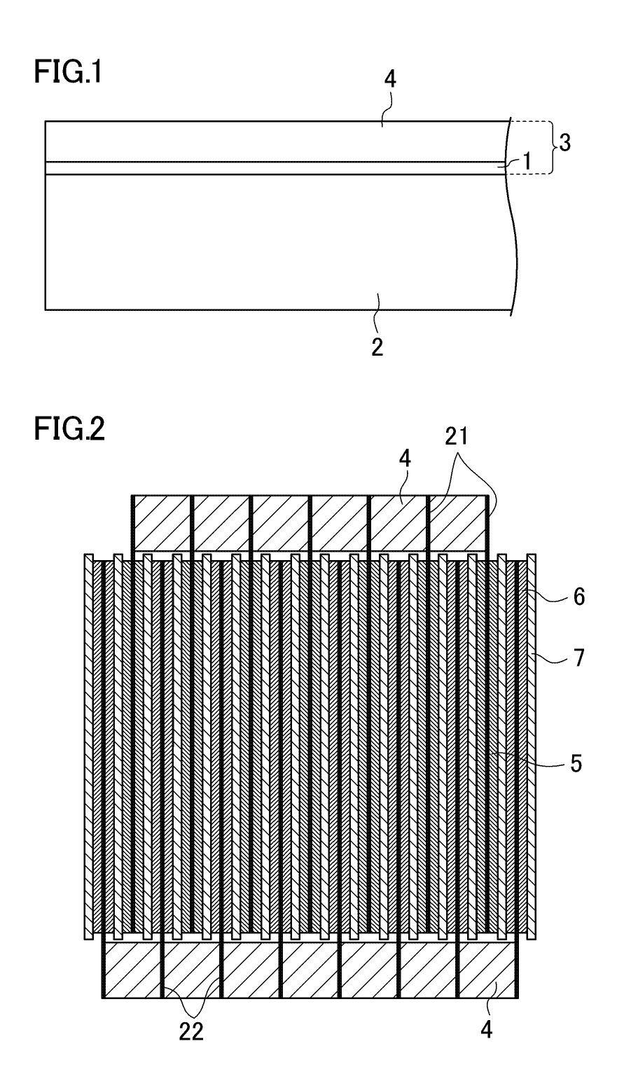

FIG. 1 is a plan view illustrating part of a positive or negative electrode constituting an electrode group of a nonaqueous electrolyte secondary battery according to an embodiment of the present invention. As shown in FIG. 1, the electrode is in the shape of a long strip, and includes an active material layer 2 formed on a surface of a current collector 1. An uncoated portion 3 on which the active material layer 2 is not formed is provided on at least one of lateral ends of the current collector 1. As shown in the cross-sectional view illustrating the electrode group of FIG. 2, a porous body 4 having a thickness larger than a distance between turns of the current collector at the end of the electrode group is provided on the current collector 1 on which the active material layer 2 is not formed.

The electrode group includes, as shown in FIG. 2, a positive electrode 5 including positive electrode active material layers formed on respective surfaces of a positive electrode current collector 21, a negative electrode 6 including negative electrode active material layers formed on respective surfaces of a negative electrode current collector 22, a porous insulator 7 as a separator sandwiched between the positive electrode 5 and the negative electrode 6, and a porous body 4 provided on each of the uncoated portions 3. The electrode group is wound, in which a plurality of turns of the electrode group overlap each other.

In winding the electrode group, part of the electrode group is already wound, and the remaining long part of the electrode group is continuously wound around the already wound part. During the winding, a constant tension is applied to the remaining long part of the electrode group, and surface pressure related to the constant tension and the diameter of the already wound part is applied to part of the electrode group where the remaining long part of the electrode group contacts the already wound part.

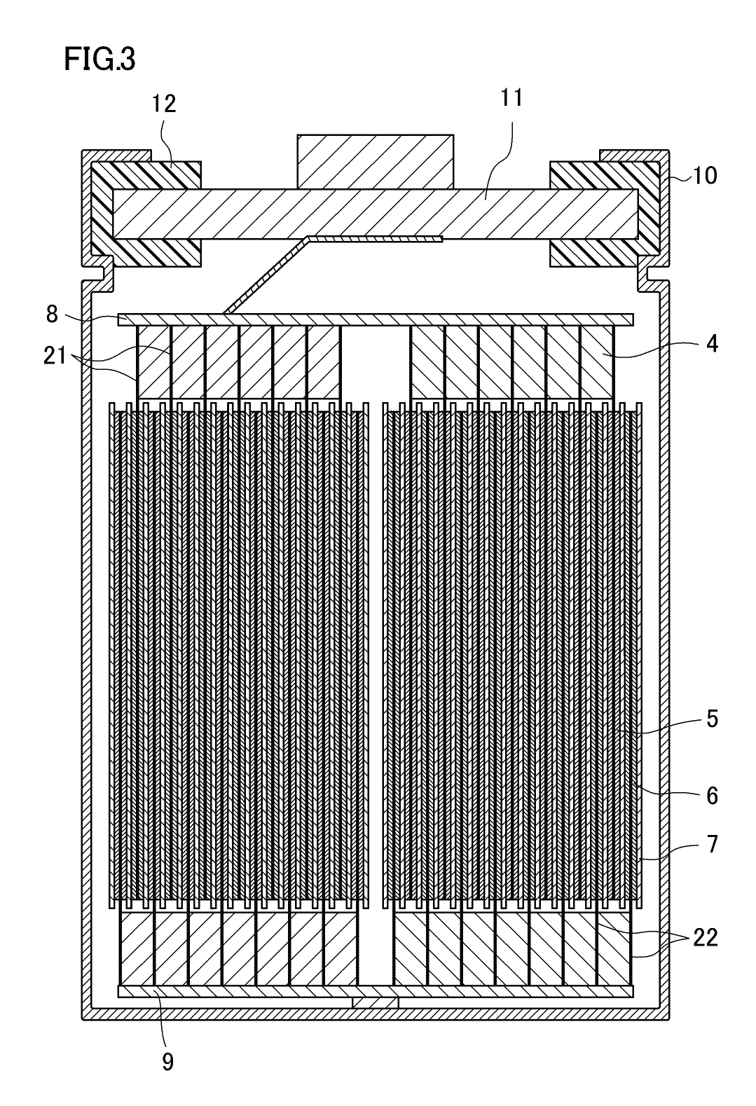

FIG. 3 shows a schematic cross-sectional view of the nonaqueous electrolyte secondary battery of the present embodiment. When the porous body 4 is not provided at the end of the electrode group, surface pressure applied during the winding to the electrode group where the remaining long part including the positive electrode, the negative electrode, and the porous insulator contacts the already wound part is relatively high at a first wound part, and is gradually reduced to a last wound part. Thus, the surface pressure varies in the radial direction of the electrode group. In contrast, according to the present embodiment, the positive and negative electrodes 5 and 6, and the separator 7 interposed therebetween are wound to form a cylindrical electrode group with the porous body 4 provided at the lateral end of each of the electrodes. Thus, the pressure generated during the winding is applied to the porous body 4 provided at the end. Although the pressure applied to the porous body 4 varies in the radial direction of the electrode group, the pressure does not vary in the radial direction in part of the electrode group where the positive electrode including the active material layers, and the negative electrode including the active material layers are wound with the porous insulator interposed therebetween. Thus, the electrodes and the separator are kept in contact during the winding. This is because the thickness of the porous body 4 is greater than a distance between turns of the current collector at the end of the electrode group. Then, a positive electrode current collector terminal 8 and a negative electrode current collector terminal 9 are welded to end faces of the positive electrode current collector 21 and the negative electrode current collector 22 exposed at the respective ends of the wound cylindrical electrode group. Then, the electrode group is placed in a case 10, and the positive electrode current collector terminal 8 and the negative electrode current collector terminal 9 are welded to a sealing plate 11 and the case 10, respectively. A nonaqueous electrolyte is injected in the case, and then the case 10 is sealed, while a gasket 12 for insulating the sealing plate 11 and the case 10 is provided at an opening of the case 10. Thus, the nonaqueous electrolyte secondary battery is obtained.

Details will be described below.

The positive electrode generally includes a positive electrode current collector, and a positive electrode material mixture supported on the positive electrode current collector. The positive electrode material mixture may contain a binder, a conductive agent, etc. in addition to a positive electrode active material. The positive electrode is formed in the following manner. For example, the positive electrode material mixture containing the positive electrode active material, and an optional component is mixed with a liquid component to prepare positive electrode material mixture slurry. Then, the positive electrode material mixture slurry is applied to the positive electrode current collector except for at least one of ends of the positive electrode current collector. Then, the applied positive electrode material mixture slurry is dried, thereby producing a positive electrode including positive electrode active material layers formed on the respective surfaces of the positive electrode current collector. If necessary, the positive electrode is rolled to a predetermined thickness, and is cut into a predetermined dimension.

Likewise, the negative electrode is formed in the following manner. A negative electrode material mixture containing a negative electrode active material, and an optional component is mixed with a liquid component to prepare negative electrode material mixture slurry, and the obtained slurry is applied to a negative electrode current collector, and is dried. Like the positive electrode, the material mixture slurry is applied to the negative electrode current collector except for at least one of ends of the negative electrode current collector, and is dried to form a negative electrode including negative electrode active material layers formed on the respective surfaces of the negative electrode current collector. If necessary, the negative electrode is rolled to a predetermined thickness, and is cut into a predetermined dimension.

Examples of the positive electrode active material include lithium metal composite oxide. For example, LiₓCoO₂, LiₓNiO₂, LiₓMnO₂, LiₓCO_{y}Ni_{1-y}O₂, LiₓCO_{y}M_{1-y}O_{z}, LiₓNi_{1-y}M_{y}O_{z}, LiₓMn₂O₄, LiₓMn_{2-y}M_{y}O₄, LiMePO₄, and Li₂MePO₄F (where M is at least one of Na, Mg, Sc, Y, Mn, Fe, Co, Ni, Cu, Zn, Al, Cr, Pb, Sb, or B) may be used (x=0−1.2, y=0−0.9, z=2.0−2.3). The value x representing the molar ratio of lithium is a value obtained from the active material immediately after the preparation, and increases or decreases through charge/charge. Part of the lithium-containing compounds may be substituted with a different element. The lithium-containing compounds may be surface-treated with metal oxide, lithium oxide, a conductive agent, etc. The surfaces of the lithium-containing compounds may be hydrophobized.

Examples of the negative electrode active material include, for example, metals, metal fibers, carbon materials, oxides, nitrides, tin compounds, silicon compounds, various types of alloys, etc. Examples of the carbon materials include, for example, various types of natural graphites, coke, partially graphitized carbon, carbon fiber, spherical carbon, various types of artificial graphites, amorphous carbon, etc. It is preferable to use silicon (Si) or tin (Sn) alone, or a silicon or tin compound in the form of an alloy, a compound, a solid solution, etc., because of their high capacity density. The silicon compound may be SiOₓ (0.05<x<1.95), or an alloy, a compound, or a solid solution of Si prepared by substituting part of Si with at least one element selected from the group consisting of B, Mg, Ni, Ti, Mo, Co, Ca, Cr, Cu, Fe, Mn, Nb, Ta, V, W, Zn, C, N, and Sn. The tin compound may be Ni₂Sn₄, Mg₂Sn, SnOₓ (0<x<2), SnO₂, SnSiO₃, etc. One of the negative electrode active materials may be used alone, or two or more of them may be used in combination. Examples of the binder contained in the positive or negative electrode include, for example, PVDF, polytetrafluoroethylene, polyethylene, polypropylene, aramid resin, polyamide, polyimide, polyamide imide, polyacrylonitrile, polyacrylic acid, poly(methyl acrylate), poly(ethyl acrylate), poly(hexyl acrylate), polymethacrylic acid, poly(methyl methacrylate), poly(ethyl methacrylate), poly(hexyl methacrylate), polyvinyl acetate, polyvinyl pyrrolidone, polyether, polyether sulfone, hexafluoropolypropylene, styrene butadiene rubber, carboxymethyl cellulose, etc. A copolymer of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Two or more materials selected from the group may be mixed. Examples of the conductive agent contained in the electrode include, for example, graphites such as natural graphites and artificial graphites, carbon blacks such as acetylene black, Ketchen black, channel black, furnace black, lamp black, thermal black, etc, conductive fibers such as carbon fibers, metal fibers, etc., carbon fluoride, metal powders such as aluminum etc., conductive whiskers such as zinc oxide, potassium titanate etc., conductive metal oxides such as titanium oxide etc., organic conductive materials such as phenylene derivatives etc.

The positive electrode active material, the conductive agent, and the binder may preferably be mixed in the ratio of 80-98 weight percent (wt. %), 1-20 wt. %, 1-10 wt. %, respectively. The negative electrode active material and the binder may preferably be mixed in the ratio of 90-99 wt. %, and 1-10 wt. %, respectively.

A long, porous or nonporous conductive substrate may be used as the current collector. The conductive substrate used as the positive electrode current collector may be made of, for example, stainless steel, aluminum, titanium, etc. The conductive substrate used as the negative electrode current collector may be made of, for example, stainless steel, nickel, copper, etc. Although not particularly limited, the thickness of the current collector is preferably 1-500 μm, more preferably 5-20 μm. With the above-described thickness range of the current collector, the electrode can be reduced in weight, while maintaining the strength.

Examples of the porous insulator which is interposed between the positive and negative electrodes, and functions as the separator include those having high ion permeability, a predetermined mechanical strength, and an insulating property, such as a thin microporous film, woven fabric, nonwoven fabric, a porous ceramic body made of ceramic and a binder, etc. For example, polyolefin such as polypropylene, polyethylene, etc., having high durability and a shut-down function is preferably used as the material of the porous insulator in view of safety of the nonaqueous electrolyte secondary battery. The thickness of the porous insulator is generally 10-300 μm, but is preferably 40 μm or smaller. The thickness of the porous insulator is more preferably 15-30 μm, much more preferably 10-25 μm. The porous insulator may be made of a monolayer film made of a single material, or a composite or multilayer film made of a single material, or two or more materials. The porous insulator preferably has a porosity of 30-70%. The porosity is a ratio of the volume of pores in the porous insulator relative to the volume of the porous insulator. The porosity is more preferably 35-60%.

The porous body 4 provided at the end of the electrode will be described below. The porous body 4 functions as a pressure equalizing member which keeps a uniform distance between adjacent turns of the positive electrode current collector, or adjacent turns of the negative electrode current collector in the wound electrode group. The porous body 4 is provided on the uncoated portion 3 at the lateral end of each of the positive electrode and the negative electrode. A member into which an electrolyte solution can penetrate, such as a porous ceramic body, nonwoven fabric made of an insulating material, etc., is used as the porous body 4. With use of the member into which the electrolyte can penetrate, the electrolyte can be distributed to the inside and outside of the electrode group. The thickness of the porous body 4 is greater by 0.5% to 5%, both inclusive, than a sum of the thickness of the positive electrode including the active material layers formed on the respective surfaces thereof, the thickness of the negative electrode including the active material layers formed on the respective surfaces thereof, and the thickness of the porous insulator 7 serving as the separator (a distance between adjacent turns of the current collector of the electrode in the wound electrode group). When the increment in thickness of the porous body 4 from the distance between the adjacent turns of the current collector is less than 0.5%, variations in surface pressure generated during the winding may affect the active material layers. When the increment is more than 5%, the adjacent turns of the electrode group may no longer contact with each other.

The porous ceramic body constituting the porous body 4 contains an inorganic oxide filler, and a binder. A material which is highly resistant to heat, and is electrochemically stable is preferably selected as the filler. For example, inorganic oxide such as alumina, magnesia, silica, etc. may be selected. The binder is added to fix the filler in the film of the porous body 4, and is preferably amorphous, and is highly resistant to heat. A rubber polymer containing a polyacrylonitrile group may be used as the binder. Slurry containing the filler and the binder is applied to the uncoated portion 3 of the electrode, and a solvent is dried, thereby forming the porous body 4 which has the above-described thickness, and is adhered to the current collector. Then, the positive and negative electrodes are wound with the separator interposed therebetween. Thus, pressure generated during the winding is applied to the porous ceramic body provided at the ends of the electrodes. The pressure applied to the porous ceramic body varies in the radial direction of the wound electrode group, but does not vary in a portion of the electrode group where the positive electrode including the active material layers, and the negative electrode including the active material layers are in contact with the separator. Thus, the positive and negative electrodes are kept in contact with the separator during the winding.

The nonwoven fabric constituting the porous body 4 is preferably nonwoven polyolefin fabric which is highly resistant to oxidation. The nonwoven fabric of the above-described thickness is provided on the uncoated portion at the end of the electrode. The nonwoven fabric can be provided on the uncoated portion by simultaneously winding the nonwoven fabric with the electrodes and the separator. Thus, pressure generated during the winding is applied to the nonwoven fabric provided at the end of the electrode group, and varies in the radial direction of the electrode group. However, the pressure does not vary in the radial direction in a portion of the electrode group where the positive electrode including the active material layers and the negative electrode including the active material layers are in contact with the separator. Thus, the positive and negative electrodes are kept in contact with the separator during the winding.

Part of the positive electrode current collector exposed at the end of the wound electrode group is connected to a positive electrode current collector plate (e.g., aluminum) 8, and part of the negative electrode current collector exposed at the end of the wound electrode group is connected to a negative electrode current collector plate (e.g., copper or nickel) 9. For example, the current collector plates may be connected by laser welding, ultrasonic welding, etc.

The nonaqueous electrolyte may be a liquid material, a gelled material, or a solid material (polymer solid electrolyte).

A liquid nonaqueous electrolyte (a nonaqueous electrolyte solution) is obtained by dissolving an electrolyte (e.g., lithium salt) in a nonaqueous solvent. The gelled nonaqueous electrolyte contains a nonaqueous electrolyte, and a polymer material supporting the nonaqueous electrolyte. Suitable examples of the polymer material include, for example, polyvinylidene fluoride, polyacrylonitrile, polyethylene oxide, polyvinyl chloride, polyacrylate, polyvinylidene fluoride hexafluoropropylene, etc.

The nonaqueous solvent for dissolving the electrolyte may be a known nonaqueous solvent. The type of the nonaqueous electrolyte is not particularly limited, but for example, cyclic carbonate, chain carbonate, cyclic carboxylate, etc. may be used. The cyclic carbonate may be propylene carbonate (PC), ethylene carbonate (EC), etc. The chain carbonate may be diethyl carbonate (DEC), ethyl methyl carbonate (EMC), dimethyl carbonate (DMC), etc. The cyclic carboxylate may be γ-butyrolactone (GBL), γ-valerolactone (GVL), etc. One of the nonaqueous solvents may be used alone, or two or more of them may be used in combination.

Examples of the electrolyte dissolved in the nonaqueous solvent include, for example, LiClO₄, LiBF₄ LiPF₆ LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borates, imidates, etc. Examples of borates include bis(1,2-benzendiolate(2-)-O,O′)borate, lithium bis(2,3-naphthalenediolate(2-)-O,O′)borate, lithium bis(2,2′-biphenyldiolate(2-)-O,O′)borate, lithium bis(5-fluoro-2-olate-1-benzenesulfonic acid-O,O′)borate, etc. Examples of imidates include lithium bis(trifluoromethylsulfonyl)imide ((CF₃SO₂)₂NLi), lithium (trifluoromethanesulfonyl)(nonafluorobutansulfonyl)imide (LiN(CF₃SO₂)(C₄F₉SO₂)), lithium bispentafluoroethanesulfonimide ((C₂F₅SO₂)₂NLi), etc. One of the electrolytes may be used alone, or two or more of them may be used in combination.

The nonaqueous electrolyte solution may contain an additive which is decomposed on the negative electrode to form a highly ion conductive coating on the negative electrode, thereby improving the charge/discharge efficiency of the battery. Examples of the additive having such a function include, for example, vinylene carbonate (VC), 4-methyl vinylene carbonate, 4,5-dimethyl vinylene carbonate, 4-ethyl vinylene carbonate, 4,5-diethyl vinylene carbonate, 4-propyl vinylene carbonate, 4,5-dipropyl vinylene carbonate, 4-phenyl vinylene carbonate, 4,5-diphenyl vinylene carbonate, vinyl ethylene carbonate (VEC), divinyl ethylene carbonate, etc. One of these additives may be used alone, or two or more of them may be used in combination. Among them, at least one selected from the group consisting of vinylene carbonate, vinyl ethylene carbonate, and divinyl ethylene carbonate is preferably used. Some of hydrogen atoms in the above-described compounds may be substituted with fluorine atoms. The amount of the electrolyte dissolved in the nonaqueous solvent is preferably in the range of 0.5-2 mol/L relative to the nonaqueous solvent.

The nonaqueous electrolyte solution may contain a known benzene derivative which is decomposed during overcharge to form a coating on the electrode, thereby inactivating the battery. The benzene derivative may preferably have a phenyl group, and a cyclic compound group adjacent to the phenyl group. Preferred examples of the cyclic compound group include a phenyl group, a cyclic ether group, a cyclic ester group, a cycloalkyl group, a phenoxy group, etc. Examples of the benzene derivative include cyclohexylbenzene, biphenyl, diphenyl ether, etc. One of these derivatives may be used alone, or two or more of them may be used in combination. The content of the benzene derivative is preferably 10 vol % or less relative to the total amount of the nonaqueous solvent.

The positive electrode and the negative electrode produced in the above-described manner are wound with the separator interposed therebetween to produce a flat electrode group. Then, the electrode group is placed in a battery case, and the positive and negative electrodes are connected to external current collector mechanisms, respectively. The nonaqueous electrolyte solution is then injected into the battery case, and a required part of the battery case is sealed. Thus, a secondary battery is obtained.

The surface pressure applied during the winding is determined by tensions applied during the winding to the positive electrode, the negative electrode, and the separator, respectively, and an area determined by a width of a portion of the electrode group where the positive and negative electrodes are in contact with the separator, and a diameter of an already wound part of the portion of the electrode group. When the tensions applied to the positive electrode, the negative electrode, and the separator are constant, the surface pressure varies depending on the diameter of the already wound part of the electrode group. Specifically, relatively high surface pressure is applied to a first wound part where the area to which the tensions are applied is small, while relatively low surface pressure is applied to a last wound part where the area to which the tensions are applied is large. When the pressure equalizing member is provided at the end of the electrode as described in the embodiment of the present invention, the pressure is applied to the pressure equalizing member, and the portion of the electrode group where the positive electrode active material layers, and the negative electrode active material layers are provided is wound, while the positive and negative electrodes are kept in contact with the porous insulator interposed therebetween. In this case, when the pressure equalizing member is extremely compressed by the pressure applied thereto, and the thickness of the pressure equalizing member becomes the same as the sum of the thickness of each of the electrodes including the active material layers formed on the respective surfaces thereof, and the thickness of the porous insulator 7 as the separator (a distance between adjacent turns of the current collector of the electrode in the electrode group), the pressure is also applied to the portion of the electrode group where the active material layers are provided. Thus, the compression of the pressure equalizing member due to the pressure related to the diameter of the already wound part is also one of parameters for the uniform surface pressure.

Examples of the present invention will be described below.

### Example 1

A method for producing a positive electrode will be described below. To a NiSO₄ aqueous solution, sulfate containing Co and Al in the predetermined ratio was added to prepare a saturated aqueous solution. An alkaline solution dissolving sodium hydroxide was slowly dropped into the saturated aqueous solution while stirring the saturated aqueous solution to neutralize the saturated aqueous solution, thereby producing a precipitate of ternary system nickel hydroxide Ni_{0.7}Co_{0.2}Al_{0.1}(OH)₂ by coprecipitation. The precipitate was filtered, washed with water, and dried at 80° C. Nickel hydroxide obtained in this manner had an average particle diameter of about 10 μm.

Ni_{0.7}Co_{0.2}Al_{0.1}(OH)₂ obtained in this manner was thermally treated in the atmosphere at 900° C. for 10 hours to obtain nickel oxide Ni_{0.7}Co_{0.2}Al_{0.1}O. Lithium hydroxide monohydrate was added in such a manner that the sum of the numbers of Ni, Co, and Al atoms was equal to the number of Li atoms, and thermal treatment was performed in dry air at 800° C. for 10 hours. Thus, lithium nickel composite oxide represented by the composition formula: LiNi_{0.7}Co_{0.2}Al_{0.1}O₂ was obtained as a positive electrode active material. The obtained material was pulverized, and classified to prepare positive electrode active material powder. The obtained powder had an average particle diameter of 9.5 μm, and a specific surface area of 0.4 m²/g.

Three kg of lithium nickel composite oxide obtained in this manner, 150 g of acetylene black, 1500 g of a solution of polyvinylidene fluoride (PVDF) dissolved in N-methylpyrrolidone (NMP) (solid content: 12%), and 1000 g of NMP were kneaded to prepare positive electrode slurry. The slurry was applied to both surfaces of 15 μm thick aluminum foil using a coater having a comma roll in such a manner that an uncoated portion of 50 mm in width was left at one lateral end on each surface of the foil. The applied slurry was dried in a drying furnace, thereby producing positive electrode active material layers on the aluminum foil. Then, the obtained positive electrode was pressed to have a total thickness of 50 μm.

A method for producing a negative electrode will be described below. Three kg of artificial graphite, and 2500 g of a PVDF solution dissolved in NMP were kneaded to prepare negative electrode slurry. The slurry was applied to both surfaces of 10 μm thick copper foil using a coater having a comma roll in such a manner that an uncoated portion of 50 mm in width was left at one lateral end on each surface of the foil. The applied slurry was dried in a drying furnace, thereby producing negative electrode active material layers on the copper foil. Then, the obtained negative electrode was pressed to have a total thickness of 60 μm.

A method for producing a porous body as the pressure equalizing member will be described below. Thousand g of alumina having a median diameter of 0.3 μm, 375 g of a binder made of polyacrylonitrile modified rubber (solid content: 8 wt. %), and an appropriate amount of a NMP solvent were kneaded to prepare heat-resistant porous slurry. The slurry was applied to the lateral end of the positive electrode. Specifically, using the comma roll coater, the porous ceramic slurry was applied to the uncoated portion on one of the surfaces of the positive electrode to be separated from the end of the positive electrode active material layer by 2 mm, and the solvent in the slurry was dried. The thickness of the solid content of the dried porous ceramic body was controlled to 137 μm corresponding to the distance between the adjacent turns of the current collector. Then, the slurry was applied to the lateral end of the negative electrode. Specifically, using the comma roll coater, the porous ceramic slurry was applied to the uncoated portion on one of the surfaces of the negative electrode to be separated from the end of the negative electrode active material layer by 1 mm, and the solvent in the slurry was dried. The thickness of the solid content of the dried porous ceramic body was controlled to 142 μm corresponding to the distance between the adjacent turns of the current collector.

The positive electrode provided with the porous ceramic body was cut into a long strip-shaped positive electrode including the porous ceramic body having a width of 10 mm, and the active material layer having a width of 95 mm. The negative electrode provided with the porous ceramic body was cut into a long strip-shaped negative electrode including the porous ceramic body having a width of 10 mm, and the active material layer having a width of 97 mm. The produced positive and negative electrodes were stacked in such a manner that the longitudinal directions thereof were aligned with each other, with the porous bodies of the positive and negative electrodes arranged at the respective lateral ends of the stack. A 20 μm thick polyethylene separator made of a porous insulator was interposed between the positive and negative electrodes, and the electrodes and the separator were wound to form a cylindrical electrode group. In this example, the porous bodies were adhered to the current collectors, and the porous bodies would not fall off the current collectors during the winding.

Then, an aluminum positive electrode current collector plate 8, and a nickel negative electrode current collector plate 9 were laser-welded to an end face of the positive electrode, and an end face of the negative electrode of the electrode group, respectively. The electrode group was then placed in a case 10, the positive electrode current collector plate 8 was laser-welded to a sealing plate 11, and the negative electrode current collector plate 9 was resistance-welded to a bottom of the case 10. Then, an electrolyte prepared by dissolving lithium hexafluorophosphate (LiPF₆) as a solute in a concentration of 1 mol/m³ in a mixed solvent of ethylene carbonate (EC) and ethyl methyl carbonate (EMC) mixed in the volume ratio of 1:3 was injected into the case under reduced pressure. Lastly, the case 10 was sealed with a gasket 12 interposed between the sealing plate 11 and the case 10. Thus, a nonaqueous electrolyte secondary battery was produced.

### Example 2

A positive electrode and a negative electrode were produced in the same manner as Example 1 except that the porous ceramic body was not provided. Then, the positive and negative electrodes were wound with the separator interposed therebetween to produce a nonaqueous electrolyte secondary battery in the same manner as Example 1 except that polyolefin nonwoven fabric of 10 mm in width, and 137 μm in thickness was inserted between the turns of the end of the positive electrode, and polyolefin nonwoven fabric of 10 mm in width, and 142 μm in thickness was inserted between the turns of the end of the negative electrode.

### Comparative Example 1

A positive electrode and a negative electrode were produced in the same manner as Example 1 except that the porous ceramic body was not provided. Then, the positive and negative electrodes were wound with the separator interposed therebetween to produce a cylindrical electrode group. Then, a nonaqueous electrolyte secondary battery was produced in the same manner as Example 1 except that the electrode group produced in this manner was used.

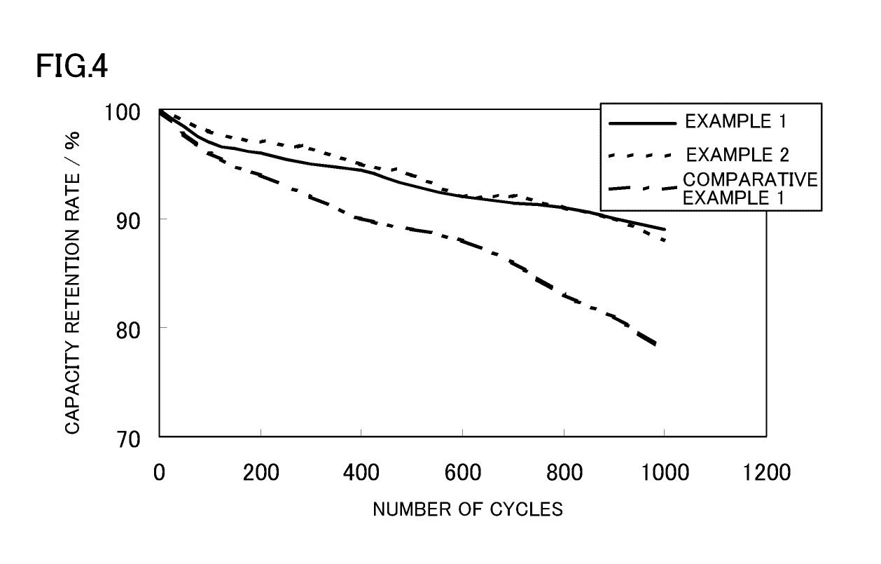

A charge/discharge cycle test was performed on the batteries of Examples 1 and 2, and Comparative Example 1 produced as described above in an environment of 25° C., at a current of 5 C hour rate, and a voltage in the range of 4.2 V-2.5 V. FIG. 4 shows a rate of retention of discharge capacity relative to the charge/discharge cycles.

In the batteries of Examples 1 and 2, pressure (surface pressure) generated during the winding of the electrodes was applied to the porous ceramic bodies or the nonwoven porous bodies at the lateral ends, and the pressure applied to them varied in the radial direction of the electrode group. However, the pressure did not vary in the radial direction in a portion of the electrode group where the positive electrode including the active material layers, and the negative electrode including the active material layers were in contact with the separator. Thus, the positive and negative electrodes were kept into contact with the separator during the winding. Further, since the porous body was provided between the turns of the electrode group at each of the ends of the electrode group, penetration of the electrolyte was not inhibited.

In contrast, in the battery of Comparative Example 1, the surface pressure varied in the radial direction of the electrode group, and relatively high surface pressure was applied to the first wound part of the electrode group, while relatively low surface pressure was applied to the last wound end part of the electrode group. As compared with the reduction in capacity retention rate of the battery of Comparative Example 1, the reduction in capacity retention rate of the batteries of Examples 1 and 2 was small even when the number of charge/discharge cycles was increased as shown in FIG. 4. In the battery of Comparative Example 1, presumably, the separator between the positive and negative electrodes was compressed unevenly due to the change in surface pressure derived from the change in diameter of the already wound part of the electrode group, and resistance between the electrodes varied among different parts of the electrode group, i.e., between the first wound part and the last wound part in the wound electrode group. As a result, the current was concentrated on the part where the resistance was low, and the degree of reduction in battery capacity was increased as the number of charge/discharge cycles was increased.

In the nonaqueous electrolyte secondary batteries of Examples 1 and 2, the electrolyte solution can penetrate smoothly, and contact pressure applied to the positive electrode, the negative electrode, and the separator can be kept uniform in the radial direction of the cylindrical electrode group, thereby allowing uniform charge/discharge reaction in the longitudinal direction of the electrode. Thus, the decrease in capacity with the increase in the number of the charge/discharge cycles can be reduced, thereby providing the battery with long life.

### Other Embodiments

The embodiment and examples described above are provided merely for the illustrative purpose, and the present invention is not limited to them. In winding the electrode group, the end of the current collector constituting the uncoated portion may be pinched with an end holding member in such a manner that the surface pressure is applied to the end holding member, and the pressure is applied to the portion of the electrode group where the active material layers are provided uniformly from the first wound part to the last wound part of the portion. The end holding member may be detached after the winding.

### INDUSTRIAL APPLICABILITY

As described above, the nonaqueous electrolyte secondary battery of the present invention is long-life, and is useful as a power source for hybrid vehicles, electric vehicles, etc.

### DESCRIPTION OF REFERENCE CHARACTERS

1 Current collector
2 Active material layer
3 Uncoated portion
4 Porous body
5 Positive electrode
6 Negative electrode
7 Separator
8 Positive electrode current collector plate
9 Negative electrode current collector plate
10 Case
11 Sealing plate
12 Gasket
21 Positive electrode current collector
22 Negative electrode current collector

1. A nonaqueous electrolyte secondary battery comprising:
a strip-shaped positive electrode including a positive electrode active material layer formed on a surface of a positive electrode current collector;
a strip-shaped negative electrode including a negative electrode active material layer formed on a surface of a negative electrode current collector;
a strip-shaped porous insulator interposed between the positive electrode and the negative electrode;
a nonaqueous electrolyte; and
a battery case containing the positive electrode, the negative electrode, the porous insulator, and the nonaqueous electrolyte, wherein
an electrode group formed by winding the positive electrode, the negative electrode, and the porous insulator is sealed in the battery case, and
a pressure which is applied to a portion of the electrode group where the positive electrode active material layer and the negative electrode active material layer are provided is substantially uniform from a first wound part to a last wound part of the portion of the electrode group.

2. The nonaqueous electrolyte secondary battery of claim 1, wherein
the positive electrode includes an uncoated portion on which the positive electrode active material layer is not formed at a lateral end thereof,
the negative electrode includes an uncoated portion on which the negative electrode active material layer is not formed at a lateral end thereof, and
pressure equalizing members are interposed between adjacent turns of the uncoated portion of the positive electrode, and between adjacent turns of the uncoated portion of the negative electrode, respectively.

3. The nonaqueous electrolyte secondary battery of claim 2, wherein
the pressure equalizing members are adhered to the uncoated portion of the positive electrode, and the uncoated portion of the negative electrode, respectively.

4. The nonaqueous electrolyte secondary battery of claim 2, wherein
each of the pressure equalizing members includes a penetration portion into which the nonaqueous electrolyte penetrates.

5. The nonaqueous electrolyte secondary battery of claim 4, wherein
the penetration portion is nonwoven fabric made of an insulating material, or a porous ceramic body.
